(19) United States
(12) Patent Application Publication
(10) Pub. No.: US 2022/0013135 A1
(43) Pub. Date: Jan. 13, 2022

(54) ELECTRONIC DEVICE FOR DISPLAYING VOICE RECOGNITION-BASED IMAGE

(71) Applicant: Samsung Electronics Co., Ltd., Suwon-si, Gyeonggi-do (KR)

(72) Inventors: Dongil SON, Suwon-si (KR); Hyoseok NA, Suwon-si (KR)

(21) Appl. No.: 17/309,278

(22) PCT Filed: Nov. 14, 2019
(86) PCT No.: PCT/KR2019/015536

§ 371 Date: May 14, 2021

(30) Foreign Application Priority Data
Nov. 16, 2018 (KR) 10-2018-0141830

(51) Int. Cl. G10L 21/10; G10L 15/18; G10L 15/22; G10L 15/26

(52) U.S. Cl. CPC G10L 21/10; G10L 15/1815; G10L 2015/088; G10L 15/26; G10L 15/22

(57) ABSTRACT

Disclosed is an electronic device. The electronic device according to an embodiment may include a microphone, a display, and a processor. The processor may be configured to receive a voice input of a user through the microphone, to identify a word having a plurality of meanings among one or more words recognized based on the voice input, in response to the voice input, and to display an image corresponding to one meaning selected from the plurality of meanings through the display in association with the word. Moreover, various embodiment found through the disclosure are possible.

### CROSS-REFERENCE TO RELATED APPLICATIONS

This application is a 371 National Stage of International Application No. PCT/KR2019/015536, filed Nov. 14, 2019, which claims priority to Korean Patent Application No. 10-2018-0141830, filed Nov. 16, 2018, the disclosures of which are herein incorporated by reference in their entirety.

### BACKGROUND

### 1. Field

Embodiments disclosed in this specification relate to a user interaction technology based on voice recognition.

### 2. Description of Related Art

As electronic devices have various functions and high-performance, a voice recognition technology is being increasingly applied to the electronic devices. The electronic devices to which a voice recognition technology is applied may recognize a user's voice input, may identify the user's request (intent) based on the voice input, and may provide functions according to the identified intent.

However, an electronic device may misrecognize the user's voice due to obstructive factors such as a distance between the electronic device and the user, a situation (e.g., a microphone is covered) of the electronic device, the user's utterance situation (e.g., food intake), or an ambient noise. When the voice is misrecognized, the electronic device may not properly perform a function requested by the user.

### SUMMARY

To prevent this problem, an electronic device may display a text (a result of converting the recognized voice into a text) corresponding to a voice input recognized during voice recognition through a display. Such the text may help a user grasp a voice recognition error of the electronic device and correct the voice recognition error while the user utters.

However, it is difficult for the user to grasp a voice recognition error based on a text. Besides, when a distance between the user and the electronic device is long, it may be difficult for the user to identify a text. Also, when the number of texts is large because a user utterance is long, it may be more difficult for the user to grasp the voice recognition error from the displayed text. In addition, when a text corresponding to a voice input includes a multisense word (a word that has a plurality of meanings), it may be difficult for the user to grasp the meaning grasped by the electronic device from the displayed text.

Various embodiments disclosed in this specification provide an electronic device displaying a voice recognition-based image that is capable of displaying an image corresponding to a word recognized in a voice recognition process.

According to an embodiment disclosed in this specification, the electronic device may include a microphone, a display, and a processor. The processor may be configured to receive a voice input of a user through the microphone, to identify a word having a plurality of meanings among one or more words recognized based on the voice input, in response to the voice input, and to display an image corresponding to one meaning selected from the plurality of meanings through the display in association with the word.

Furthermore, according to an embodiment disclosed in this specification, an electronic device may include a microphone, a display, a processor operatively connected to the microphone and the display, and a memory operatively connected to the processor. The memory may store instructions that, when executed, cause the processor to receive a voice input of a user through the microphone, to detect a keyword among one or more words recognized based on the received voice input, and to display an image corresponding to the keyword through the display in association with the keyword.

According to the embodiments disclosed in this specification, it is possible to display an image corresponding to a word recognized in a voice recognition process.

Besides, a variety of effects directly or indirectly understood through the specification may be provided.

### BRIEF DESCRIPTION OF THE DRAWINGS

FIG. 1 is a diagram for describing a method of providing a function corresponding to a voice input according to an embodiment.

FIG. 2 is a block diagram of an electronic device, according to an embodiment.

FIG. 3 illustrates an example of a UI screen of displaying one image corresponding to a keyword having a plurality of meanings according to an embodiment.

FIG. 4 illustrates another example of a UI screen of displaying one image corresponding to a keyword having a plurality of meanings according to an embodiment.

FIG. 5 illustrates an example of a UI screen of displaying a plurality of images corresponding to a keyword having a plurality of meanings according to an embodiment.

FIG. 6 illustrates a UI screen in a process of correcting a voice recognition error based on an image corresponding to a keyword having one meaning according to an embodiment.

FIG. 7 is an exemplary diagram of an electronic device, which does not include a display, according to an embodiment.

FIGS. 8A and 8B illustrate examples of displaying a plurality of images corresponding to a plurality of keywords according to an embodiment.

FIG. 9 is a flowchart illustrating a method for displaying an image based on voice recognition according to an embodiment.

FIG. 10 is a flowchart illustrating an image-based voice recognition error verifying method according to an embodiment.

FIG. 11 illustrates another example of an image-based voice recognition error verifying method according to an embodiment.

FIG. 12 illustrates a block diagram of an electronic device in a network environment according to various embodiments.

FIG. 13 is a block diagram illustrating an integrated intelligence system, according to an embodiment.

FIG. 14 is a diagram illustrating the form in which relationship information between a concept and an action is stored in a database, according to an embodiment.

FIG. 15 is a view illustrating a user terminal displaying a screen of processing a voice input received through an intelligence app, according to an embodiment.

With regard to description of drawings, the same or similar components will be marked by the same or similar reference signs.

### DETAILED DESCRIPTION

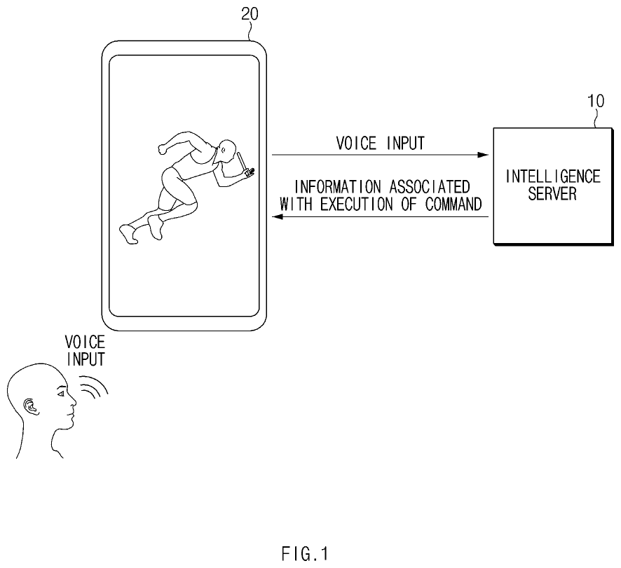

FIG. 1 is a diagram for describing a method of providing a function corresponding to a voice input according to an embodiment.

Referring to FIG. 1, when an electronic device 20 obtains a user's voice input through a microphone, the electronic device 20 may perform a command according to the user's intent based on the voice input. For example, when the electronic device 20 obtains the voice input, the electronic device 20 may convert the voice input into voice data (e.g., pulse code modulation (PCM) data) and may transmit the converted voice data to an intelligence server 10.

When the intelligence server 10 receives the voice data, the intelligence server 10 may convert the voice data into text data and may determine a user's intent based on the converted text data. The intelligence server 10 may determine a command (including a single command or a plurality of commands) according to the determined intent of the user and may transmit information associated with execution of the determined command to the electronic device 20. For example, the information associated with the execution of the command may include information of an application executing the determined command and information about a function that the application executes.

According to an embodiment, when the electronic device 20 receives information associated with command execution from the intelligence server 10, the electronic device 20 may execute a command corresponding to the user's voice input based on information associated with the command execution. The electronic device 20 may display a screen associated with the command, during the execution of the command or upon completing the execution of the command. For example, the screen associated with the command may be a screen provided from the intelligence server 10 or a screen generated by the electronic device 20 based on the information associated with the command execution. For example, the screen associated with the command may include at least one of a screen guiding an execution process of the command or a screen guiding an execution result of the command.

According to an embodiment, the electronic device 20 may display an image corresponding to at least part of words recognized based on a voice input in a process of voice recognition. For example, the process of voice recognition may include a process of receiving a voice input after a voice recognition service is started, recognizing a word based on the voice input, determining the user's intent based on the recognized word, and determining a command according to the user's intent. For example, the process of voice recognition may be before the command according to the user's intent is performed based on the voice input after a voice recognition service is started. As another example, the process of voice recognition may be before a screen associated with the user's intent is output based on the voice input after the voice recognition service is started.

According to various embodiments, at least part of functions of the intelligence server 10 may be executed by an electronic device 20. For example, the electronic device 20 may convert an obtained voice input into voice data, may convert the voice data into text data, and may transmit the converted text data to the intelligence server 10. As another example, the electronic device 20 may perform all the functions of the intelligence server 10. In this case, the intelligence server 10 may be omitted.

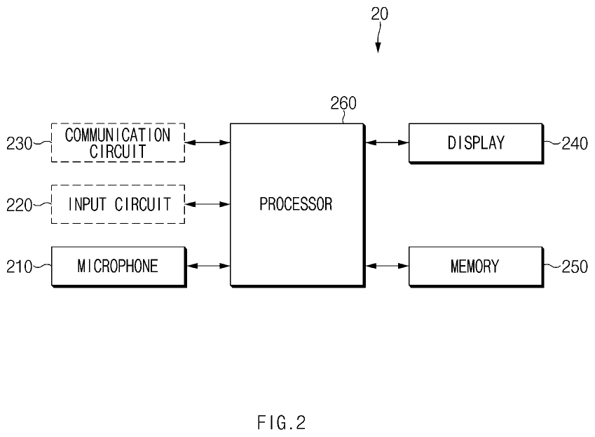

FIG. 2 is a block diagram of an electronic device, according to an embodiment.

Referring to FIG. 2, according to an embodiment, the electronic device 20 may include a microphone 210, an input circuit 220, a communication circuit 230, a display 240, a memory 250, and a processor 260. In an embodiment, the electronic device 20 may not include some of the above components or may further include any other components. For example, the electronic device 20 may be a device that does not include the display 240 (e.g., an AI speaker), and may use the display 240 included in an external electronic device (e.g., a TV or a smartphone). As another example, the electronic device 20 may further include the input circuit 220 for detecting or receiving a user's input. In an embodiment, some of the components of the electronic device 20 may be combined to form one entity, which may identically perform functions of the some components before the combination. The electronic device 20 may include, for example, a portable communication device (e.g., a smartphone), a computer device, a portable multimedia device, a mobile medical appliance, a camera, a wearable device, or a home appliance (e.g., an AI speaker).

According to an embodiment, the microphone 210 may receive a voice input by a user utterance. For example, the microphone 210 may detect a voice input according to a user utterance and may generate a signal corresponding to the detected voice input.

According to an embodiment, the input circuit 220 may detect or receive a user input (e.g., a touch input). For example, the input circuit 220 may be a touch sensor combined with the display 240. The input circuit 220 may further include a physical button at least partially exposed to the outside of the electronic device 20.

According to an embodiment, the communication circuit 230 may communicate with the intelligence server 10 through a specified communication channel. For example, the specified communication channel may be a communication channel in a wireless communication method such as WiFi, 3G, 4G, or 5G.

According to an embodiment, the display 240 may display various pieces of content (e.g., a text, an image, a video, an icon, and/or a symbol). The display 240 may include, for example, a liquid crystal display (LCD), a light-emitting diode (LED) display, an organic LED (OLED) display, or an electronic paper display.

According to an embodiment, the memory 250 may store, for example, commands or data associated with at least one other component of the electronic device 20. The memory 250 may be a volatile memory (e.g., a random access memory (RAM) or the like), a nonvolatile memory (e.g., a read only memory (ROM), a flash memory, or the like), or a combination thereof. According to an embodiment, the memory 250 may store instructions that cause the processor 260 to detect a keyword among one or more words recognized based on the voice input received through the microphone 210 and to display an image corresponding to the keyword through the display 240 in associated with the keyword. The keyword may include at least one of a word having a plurality of meanings, a word associated with a name (a unique noun or a pronoun) of a person or thing, or a word associated with an action. The meaning of a word may be the unique meaning of the word, and may be a parameter (e.g., an input/output value) required to determine a command according to the user's intent based on the word.

According to an embodiment, the processor 260 may perform data processing or an operation associated with a control and/or a communication of at least one other component(s) of the electronic device 20 by using instructions stored in the memory 250. For example, the processor 260 may include at least one of a central processing unit (CPU), a graphic processing unit (GPU), a microprocessor, an application processor (AP), an application specific integrated circuit (ASIC), and a field programmable gate arrays (FPGA) and may have a plurality of cores.

According to an embodiment, when identifying a voice input (hereinafter referred to as “wake-up utterance”) requesting the initiation (start) of a service based on a voice input through the microphone 210, or identifying a user input (e.g., a touch input) requesting the start of the service based on the voice input through the input circuit 220, the processor 260 may perform a voice recognition function. When performing the voice recognition function, the processor 260 may receive a voice input according to a user's utterance through the microphone 210, may recognize one or more words based on the received voice input, and may execute a command according to the user's intent determined based on the recognized words. The processor 260 may output a screen associated with a command, during the execution of the command or upon completing the execution of the command. For example, the screen associated with the command may include at least one of a screen guiding an execution process of the command or a screen guiding an execution result of the command.

According to an embodiment, the processor 260 may receive a voice input through the microphone 210 and may detect a keyword among one or more recognized words based on the received voice input. For example, the processor 260 may detect a keyword based on a voice input received during voice recognition. For example, the process of voice recognition may include a process of receiving a voice input after a voice recognition service is started, recognizing a word based on the voice input, determining the user's intent based on the recognized word, and determining a command according to the user's intent. For another example, the process of voice recognition may be before the command according to the user's intent is performed based on the voice input after a voice recognition service is started. As another example, the process of voice recognition may be before a screen associated with the user's intent is output based on the voice input after the voice recognition service is started.

According to an embodiment, when a keyword among the recognized words is detected, the processor 260 may obtain an image corresponding to the keyword, and may display the obtained image through the display 240 in association with the keyword. The image corresponding to the keyword may be an image mapped to the keyword in advance. The image corresponding to the keyword may include an image that allows the user to remind the keyword from an image corresponding to the keyword. For example, when the keyword is a word associated with a name of a person or thing having a shape, the image corresponding to the keyword may include an image representing the shape of a person or object. As another example, when the keyword is a word associated with an object without a shape (e.g., a company name), the image corresponding to the keyword may include a logo (e.g., a company logo) or a symbol. As another example, when the keyword is a word associated with an action, the image corresponding to the keyword may include an image representing the action.

The processor 260 may obtain an image corresponding to a keyword from the memory 250 or an external electronic device (e.g., the intelligence server 10, a portal server, or a social network server). For example, the processor 260 may search for an image corresponding to a keyword from the memory 250; when there is an image corresponding to the keyword in the memory 250, the processor 260 may obtain the image corresponding to the keyword from the memory 250. When there is no image corresponding to the keyword in the memory 250, the processor 260 may obtain the image from the intelligence server 10.

The processor 260 may make up a sentence by using words recognized depending on a voice input; as the processor 260 emphasizes the keyword (e.g., a bold type) upon displaying the corresponding sentence on the display 240, the processor 260 may display the corresponding sentence in association with an image corresponding to a keyword. Additionally or alternatively, the processor 260 may display the keyword in proximity to an image corresponding to the keyword (e.g., placing a keyword at a lower portion of the image).

According to an embodiment, when the detected keyword is a word having a plurality of meanings, the processor 260 may select one meaning among the plurality of meanings and may display an image corresponding to the selected meaning.

According to an embodiment, when the detected keyword is a word having a plurality of meanings, the processor 260 may respectively calculate probabilities of a keyword with respect to the plurality of meanings, may select one meaning with the highest probability among the calculated probabilities, and may display only one image corresponding to the selected single meaning. In this regard, the processor 260 may respectively calculate probabilities of the meaning of a keyword with respect to a plurality of meanings, based on a history, in which the plurality of meanings are used, or information about the user's propensity and may select one meaning with the highest probability among the plurality of meanings. For example, the processor 260 may calculate the highest probability of a meaning, which is most frequently used and is most recently used, from among the plurality of meanings, based on a history in which the plurality of meanings are used in the electronic device 20. As another example, when it is impossible to respectively calculate probabilities of a keyword with respect to a plurality of meanings, based on a history in which the plurality of meanings are used in the electronic device 20 (e.g., when there is no history in which any one of the plurality of meanings is used in the electronic device 20), the processor 260 may calculate the highest probability of a meaning, which is used most frequently and most recently, from among the plurality of meanings based on a history in which the plurality of meanings are used by the external electronic device 20. As another example, the processor 260 may respectively calculate probabilities of a meaning of a keyword with respect to a plurality of meanings based on information about the user's propensity, for example, preferences of a plurality of users having an interest field that is identical or similar to that of the user.

In an embodiment, when the processor 260 displays only an image corresponding to the selected single meaning with the highest probability of a keyword, in the case where there is another meaning having a difference, which is not greater than a specified probability difference (e.g., about 5%), from the selected single meaning, the processor 260 may apply another effect (e.g., highlighting a border) to an image corresponding to the selected single meaning so as to represent the other meaning. In an embodiment, the processor 260 may display an image corresponding to the other meaning together with the image corresponding to one meaning having the highest probability. In this case, the processor 260 may display the image corresponding to the meaning having the highest probability of a keyword, at the largest size and may display the image corresponding to the other meaning at a relatively small size. According to one embodiment, when the detected keyword is a word having a plurality of meanings, the processor 260 may display a plurality of images corresponding to the plurality of meanings, and may select one meaning among the plurality of meanings based on a user input (e.g., touch input) to the displayed images. For example, the processor 260 may display the plurality of images respectively corresponding to the plurality of meanings through the display 240 in association with a keyword and may select one meaning corresponding to one image, which is selected by a user input, from among the plurality of images displayed through the display 240.

In an embodiment, when displaying a plurality of images respectively corresponding to a plurality of meanings, the processor 260 may distinguish and display the plurality of images based on probabilities of the meaning of a keyword with respect to a plurality of meanings, respectively. For example, the processor 260 may display an image corresponding to a meaning having the highest probability of the meaning of a keyword, at the largest size or may display the image after applying another effect (e.g., highlighting a border) to the image.

According to an embodiment, the processor 260 may detect a plurality of keywords among words recognized based on a voice input. The plurality of keywords may include at least one of a word having one meaning or a word having a plurality of meanings. When the processor 260 detects a plurality of keywords based on a voice input, the processor 260 may sequentially display a plurality of images corresponding to the plurality of keywords. For example, the fact that the plurality of images are sequentially displayed may be that the plurality of images are respectively displayed as different screens. Alternatively, when the processor 260 detects a plurality of keywords based on a voice input, the processor 260 may display the plurality of images respectively corresponding to the plurality of keywords on a single screen in chronological order. For example, after the reception of voice input is completed, the processor 260 may arrange and display the plurality of images corresponding to keywords detected based on a voice input. For example, the fact that the plurality of images are arranged and displayed may be that the plurality of images are displayed on a single screen. In this case, the plurality of images may be arranged and displayed in order in which a plurality of keywords are detected.

According to an embodiment, when there is another voice input to an image displayed in association with a keyword, the processor 260 may change an image corresponding to the keyword based on the other voice input. The other voice input may be a voice input entered within a specified time from a point in time when an image is displayed in association with the keyword, and may include at least one of a word associated with another meaning of the keyword, a negative word, a keyword, or a pronoun.

When recognizing a word associated with another meaning that is not selected from a plurality of meanings based on a voice input within specified time, the processor 260 may determine that there is another voice input to the image displayed in association with the keyword. Alternatively, when recognizing at least one of a keyword, a negative word, or a pronoun, in addition to the word associated with the other meaning that is not selected within the specified time, the processor 260 may determine that there is another voice input. In response to the other voice input, the processor 260 may display another image corresponding to another meaning, which is selected based on another voice input, from among a plurality of meanings in association with the keyword through the display 240.

According to an embodiment, when there is another voice input to the displayed image in association with the keyword, the processor 260 may correct the meaning of the keyword to another meaning selected based on another voice input. Alternatively, when there is another voice input to the displayed image in association with the keyword, the processor 260 may correct or replace a keyword in a sentence including a keyword to or with a phrase including a word associated with the other meaning. The processor 260 may determine a command according to the user's intent, based on the sentence including a keyword recognized based on another voice input, excluding a sentence including a keyword recognized based on a voice input from a command determination target according to the user's intent.

According to an embodiment, after voice reception is completed, the processor 260 may display an image corresponding to all keywords detected based on a voice input. When a plurality of keywords are detected based on a voice input, the processor 260 may display a plurality of images respectively corresponding to a plurality of keywords. With respect to a keyword having a plurality of meanings among a plurality of keywords, the processor 260 may display a plurality of images respectively corresponding to the plurality of meanings. Until a screen associated with a command corresponding to a voice input is displayed, the processor 260 may output an image corresponding to a keyword.

According to an embodiment, when there is a keyword that has a plurality of meanings among words recognized based on the voice input, the processor 260 may delay command determination based on a voice input until the selected single meaning of the at least corresponding keyword is determined. For example, when a user input or another voice input is not received during a specified time after an image corresponding to one meaning selected from a plurality of meanings is displayed, the processor 260 may determine that the keyword is the selected single meaning. In this case, the processor 260 may transmit, to the intelligence server 10, information indicating that the meaning of the keyword is determined as the selected single meaning. As another example, when a user input or another voice input for selecting another meaning that is not selected within a specified time is received after an image corresponding to one meaning selected from a plurality of meanings is displayed, the processor 260 may determine that the meaning of the keyword is another meaning according to the user input or the other voice input. In this case, the processor 260 may transmit, to the intelligence server 10, information indicating that the meaning of the keyword is determined as the other meaning.

According to various embodiments, at least part of operations of the processor 260 described above may be performed by the intelligence server 10. For example, the processor 260 may transmit a voice input or another voice input to the intelligence server 10 such that the intelligence server 10 determines whether there is a word having a plurality of meanings among words recognized, selects one of the plurality of meanings, and provides the electronic device 20 with an image corresponding to the selected single meaning. In this case, the electronic device 20 may display an image corresponding to the selected single meaning and may transmit, to the intelligence server 10, a user input, another voice input, or information for providing a notification of the determination about the selected single meaning within a specified time after the image is displayed.

According to various embodiments, the processor 260 may detect a word having one meaning as a keyword and may display an image corresponding to the keyword in association with the keyword. When another voice input is received within a specified time after the image is displayed in association with the keyword, the processor 260 may correct the detected keyword based on another voice input. For example, when recognizing a negative word that negates a keyword, and a substitute word, in addition to the keyword, based on a voice input within a specified time after the image is displayed in association with the keyword, the processor 260 may identify that the voice input is another voice input for correcting the keyword. In this case, the processor 260 may correct the keyword to the substitute word.

According to the above-described embodiment, upon displaying an image corresponding to the keyword, the electronic device 20 may support the user to easily detect whether an error occurs in words recognized based on a voice input, with respect to the keyword having at least a plurality of meanings.

In addition, according to the above-described embodiment, the electronic device 20 may support the user to easily correct an error in a voice recognition process based on a user input or another voice input to the image displayed in association with the recognized word.

The electronic device (e.g., the electronic device 20 of FIG. 2) according to an embodiment may include a microphone (e.g., the microphone 210 of FIG. 2), a display (e.g., the display 240 of FIG. 2), and a processor (e.g., the processor 260 of FIG. 2). The processor may be configured to receive a voice input of a user through the microphone, to identify a word having a plurality of meanings among one or more words recognized based on the voice input, in response to the voice input, and to display an image corresponding to one meaning selected from the plurality of meanings through the display in association with the word.

The processor may be configured to display another image corresponding to another meaning selected based on the other voice input among the plurality of meanings in response to the other voice input through the display in association with the word when there is another voice input to the image displayed in association with the word.

The processor may be configured to calculate probabilities of a meaning according to the voice input with respect to the plurality of meanings, respectively and to select the one meaning corresponding to the highest probability among the calculated probabilities.

The processor may be configured to calculate probabilities respectively associated with the plurality of meanings based on a history in which the word is used by the electronic device or an external electronic device.

The processor may be configured to determine that the other voice input is present, when recognizing a word associated with another meaning that is not selected from the plurality of meanings based on the voice input within a specified time.

The processor may be configured to determine that the other voice input is present, when recognizing at least one word of a negative word or a pronoun as well as a word associated with the other meaning within the specified time based on the voice input.

The electronic device may further include an input circuit (e.g., the input circuit 220 of FIG. 2). The processor may be configured to display a plurality of images respectively corresponding to the plurality of meanings through the display in association with the word when identifying words having the plurality of meanings, and to display an image corresponding to the one meaning corresponding to one image selected through the input circuit among the plurality of images through the display.

The processor may be configured to determine the word as the selected one meaning when the other voice input to the image displayed in association with the word is not present.

The electronic device may further include a communication circuit (e.g., the communication circuit 230 of FIG. 2) communicating with an external electronic device. The processor may be configured to transmit the voice input and the other voice input to the external electronic device such that the external electronic device determines whether the other voice input to the image displayed in association with the word is present, and determines the one meaning among the plurality of meanings based on the other voice input.

According to an embodiment, an electronic device (e.g., the electronic device 20 of FIG. 2) may include a microphone (e.g., the microphone 210 of FIG. 2), a display (e.g., the display 240 of FIG. 2), a processor (e.g., the processor 260 of FIG. 2) operatively connected to the microphone and the display, and a memory (e.g., the memory 250 of FIG. 2) operatively connected to the processor. The memory may store instructions that, when executed, cause the processor to receive a voice input of a user through the microphone, to detect a keyword among one or more words recognized based on the received voice input, and to display an image corresponding to the keyword through the display in association with the keyword.

The instructions may further cause the processor to detect a word having a plurality of meanings, a word associated with a name, or a word associated with an action among the recognized one or more words as the keyword.

The instructions may further cause the processor to display a plurality of images corresponding to the plurality of meanings when the keyword is a word having a plurality of meanings and to display an image corresponding to one meaning selected from the plurality of meanings through the display based on an input of a user for selecting one image among the plurality of images.

The instructions may further cause the processor to calculate probabilities of a meaning of the keyword with respect to the plurality of meanings, respectively and to display an image corresponding to the one meaning having the highest probability at the largest size.

The instructions may further cause the processor to calculate probabilities of a meaning of the keyword with respect to the plurality of meanings, respectively when the keyword is a word having a plurality of meanings and to display one image corresponding to the one meaning having the highest probability among the calculated probabilities.

The instructions may further cause the processor to sequentially display the plurality of images corresponding to the plurality of keywords when detecting a plurality of keywords based on the received voice input.

The instructions may further cause the processor to arrange and display a plurality of images respectively corresponding to the plurality of keywords when detecting a plurality of keywords based on the received voice input.

The instructions may further cause the processor to correct the keyword based on the other voice input when there is another voice input to the image displayed in association with the keyword.

The instructions may further cause the processor to exclude a sentence including the keyword when there is another voice input to the image displayed in association with the keyword and to determine a command based on a voice input excluding the sentence.

The instructions may further cause the processor to determine that the other voice input is present when a voice input including at least one of the keyword, a negative word, or a pronoun is received within the specified time.

The instructions may further cause the processor to determine a command according to intent of a user based on the voice input when the reception of the voice input is terminated, to display a screen associated with the command through the display, in an execution process or an execution termination of the command, and to display the image until a screen associated with the command is displayed.

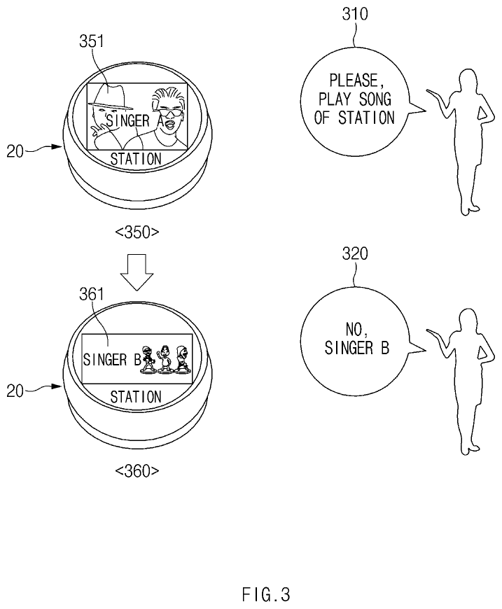

FIG. 3 illustrates an example of a UI screen of displaying one image corresponding to a keyword having a plurality of meanings according to an embodiment.

Referring to FIG. 3, when receiving a user's voice input 310 “please, play a song of STATION”, the electronic device 20 may detect a word ‘STATION’ having a plurality of meanings as a keyword. For example, the electronic device 20 may identify pieces of sound source information by using a keyword ‘STATION’ as a name, and may identify that the keyword ‘STATION’ is a word having a plurality of meanings, that is, pieces of sound source information (e.g., the name of a singer).

On screen 350, the electronic device 20 may display, through the display 240 (e.g., the display 240 in FIG. 2), an image 351 corresponding to single sound source information “STATION of singer A” selected from pieces of sound source information in association with the keyword ‘STATION’. For example, the image 351 corresponding to “STATION of singer A” may be an album cover image of ‘STATION’ of singer A. In this regard, the electronic device 20 may select single sound source information, which has been used (e.g., played or downloaded) by the electronic device 20, based on pieces of sound source information. When two or more pieces of sound source information among pieces of sound source information have been used by the electronic device 20, the electronic device 20 may select sound source information corresponding to at least one of the most frequently-used sound source information or the most recently-used sound source information among the two or more pieces of sound source information. When the pieces of sound source information have not been used (e.g., played or downloaded) by the electronic device 20, the electronic device 20 may select, for example, single sound source information of which the most recent use frequency is not less than a specified frequency, based on a history in which the pieces of sound source information have been used by the external electronic device. Alternatively, when the pieces of sound source information have not been used (e.g., played or downloaded) by the electronic device 20, the electronic device 20 may select one sound source based on user propensity information, for example, a genre of a sound source that has been played by a user.

The electronic device 20 may recognize a negative word ‘No’ and a word ‘singer B’ associated with another sound source (corresponding to the meaning of the above-described other sound source that is not selected) that has not been selected, based on a second voice input 320 of “No, singer B” within a specified time after the image 351 is displayed. In this case, the processor 260 may identify that the second voice input 320 is another voice input to the image 351 displayed in association with the keyword ‘STATION’, and may select another meaning “STATION of singer B” as the meaning of the keyword based on the second voice input 320.

On screen 360, in response to the second voice input 320, the electronic device 20 may display another image 361 corresponding to the keyword ‘STATION’, for example, an image corresponding to “STATION of singer B” in association with the keyword ‘STATION’, through the display 240. For example, the image 361 corresponding to “STATION of singer B” may be an album cover image of “STATION of singer B”.

According to an embodiment, the electronic device 20 may determine the playback of a sound source of “STATION of singer B” as a user's intent, may determine a command to play the sound source of “STATION of singer B”, and may play STATION of ‘singer B’ upon executing the determined command.

According to the above-described embodiment, when identifying a word having a plurality of meanings among one or more words recognized based on the received voice input, the electronic device 20 may assist to easily identify and correct an error in a voice recognition process upon displaying an image corresponding to a meaning selected from the plurality of meanings.

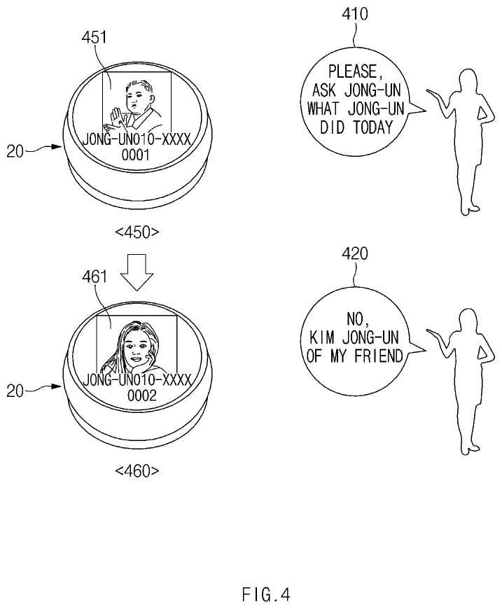

FIG. 4 illustrates another example of a UI screen of displaying one image corresponding to a keyword having a plurality of meanings according to an embodiment.

Referring to FIG. 4, when receiving a user's voice input 410 “please, ask Jong-un what Jong-un did today”, the electronic device 20 may detect a word “Jong-un” having a plurality of meanings as a keyword. For example, the electronic device 20 may identify pieces of contact information stored as the keyword “Jong-un” from an address book, and may identify that the keyword “Jong-un” is a word having a plurality of meanings, that is, pieces of contact information (e.g., a phone number).

On screen 450, the electronic device 20 may display an image 451 corresponding to a piece of contact information of “Jong-un 1” selected from pieces of contact information including the keyword “Jong-un” in association with the keyword “Jong-un”. For example, the image 451 corresponding to “Jong-un 1” may be a photo image (e.g., a profile image stored in a social network) obtained from the electronic device 20 or an external electronic device (e.g., a social network server), based on contact information of Jong-un 1. In this regard, the electronic device 20 may select contact information corresponding to at least one of contact information having the highest use frequency or the most recently-used contact information among the pieces of contact information. According to various embodiments, the electronic device 20 may display the image 451 and the contact information “Jong-un 1” (010-XXXX-0001).

The electronic device 20 may recognize a negative word ‘No’, a keyword “Jong-un”, and words “my friend” and “Kim Jong-un” associated with other contact information not selected, based on a second voice input 420 of “No, Kim Jong-un of my friend” within a specified time after the image 451 corresponding to “Jong-un 1” is displayed. The electronic device 20 may determine that the second voice input 420 is another voice input to the image 451 displayed in association with the keyword “Jong-un”, and may correct the meaning of the keyword “Jong-un” to contact information of Kim Jong-un (Jong-un 2) belonging to a friend group based on the second voice input 420.

On screen 460, the electronic device 20 may display another image 461 selected based on a second voice input, for example, an image corresponding to contact information belonging to the friend group in association with the keyword “Jong-un”. For example, the other image 461 selected based on the second voice input may be a photo image (e.g., a profile image stored in a social network) obtained from the electronic device 20 or an external electronic device based on contact information of Kim Jong-un belonging to the friend group. According to various embodiments, the electronic device 20 may display the other image 461 in association with the contact information (010-XXXX-0002) of Jong-un 2.

According to the above-described embodiment, when identifying a word having a plurality of meanings among one or more words recognized based on the received voice input, the electronic device 20 may assist to intuitively identify that an error occurs in a voice recognition process, upon displaying an image corresponding to a meaning selected from the plurality of meanings.

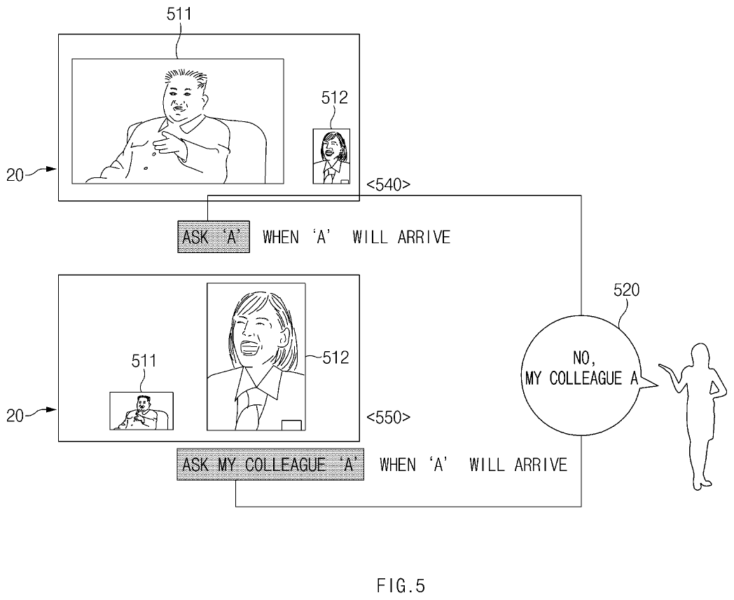

FIG. 5 illustrates an example of a UI screen of displaying a plurality of images corresponding to a keyword having a plurality of meanings according to an embodiment.

Referring to FIG. 5, according to an embodiment, the electronic device 20 may display a plurality of images respectively corresponding to a plurality of meanings, with respect to a word having the plurality of meanings among one or more words recognized based on a first voice input.

On screen 540, when receiving a first voice input 510 “ask ‘A’ when ‘A’ will arrives”, the electronic device 20 may detect a multisense word ‘A’ having a plurality of meanings as a keyword and may display a first image 511 and a second image 512 respectively corresponding to the first meaning (contact information of ‘A’ 1) and the second meaning (contact information of ‘A’ 2) of the keyword ‘A’ . In this regard, the electronic device 20 may respectively calculate probabilities of a meaning of a keyword with respect to a plurality of meanings, based on at least one of a history, in which the plurality of meanings have been used, or user propensity information and may display the first image 511 corresponding to the selected meaning having the highest probability among the calculated probabilities at a size greater than that of the second image 512.

The electronic device 20 may receive a second voice input 520 “No, my colleague A” within a specified time after screen 540 is displayed. The electronic device 20 may recognize a negative word “no”, a keyword ‘A’, and the other meaning “my” and “colleague” of the keyword ‘A’, based on a second voice input. The electronic device 20 may determine that the second voice input is another voice input to the first image 511 and the second image 512 displayed in association with ‘A’. The electronic device 20 may determine that the meaning of the keyword ‘A’ is the contact information of ‘A’ 2 belonging to a colleague group, based on the other voice input.

On screen 550, based on the second voice input that is the other voice input, the electronic device 20 may decrease a size of the first image 511 corresponding to the keyword ‘A’ and may increase a size of the second image 512 corresponding to the keyword ‘A’; and, the electronic device 20 may display the first image 511 and the second image 512. According to various embodiments, based on another voice input, the electronic device 20 may display only the second image 512 corresponding to the other selected meaning without displaying the first image 511.

Afterward, upon correcting the keyword ‘A’ to colleague ‘A’ in a sentence “ask ‘A’ when ‘A’ will arrive” composed of words recognized based on the first voice input 510, the electronic device 20 may determine a command according to a user's intent based on a sentence “ask my colleague ‘A’ when ‘A’ will arrive”. For example, the command according to the user's intent may be a command to send a text “when you will arrive” to “colleague A”.

According to various embodiments, the electronic device 20 may identify a user input (e.g., a touch input to the second image 512) to select the second image 512 instead of receiving the second voice input 520 within a specified time after screen 540 is displayed, and may determine that the meaning of the keyword ‘A’ is contact information of ‘A’ 2 belonging to a colleague group depending on the corresponding user input.

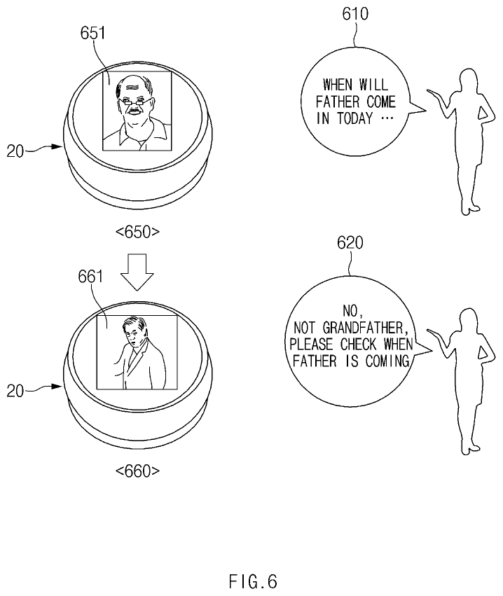

FIG. 6 illustrates a UI screen in a process of correcting a voice recognition error based on an image corresponding to a word having one meaning according to an embodiment.

Referring to FIG. 6, on screen 650, the electronic device 20 may misrecognize a word ‘father’ associated with a name as ‘grandfather’ in a process of recognizing a first voice input 610 of “when will father come in today?”, and may display an image 651 corresponding to the misrecognized keyword ‘grandfather’. For example, when the electronic device 20 is capable of obtaining a photo image of a user's ‘grandfather’ from the memory 250, the electronic device 20 may display an image of the user's grandfather. As another example, when the electronic device 20 is incapable of obtaining the image of the user's grandfather from the memory 250, the electronic device 20 may select a grandfather image corresponding to the user's age from images corresponding to a grandfather stored in the electronic device 20 or an external electronic device (e.g., the intelligence server 10 (e.g., the intelligence server 10 in FIG. 1)). In this regard, the images, which are stored in the intelligence server 10 and correspond to a grandfather, may be stored in association with age information of a speaker (user). The electronic device 20 may select an image corresponding to a grandfather based on the age information of the speaker.

The electronic device 20 may receive a second voice input 620 to correct a first voice input “No, not grandfather, please check when father is coming” within a specified time after the image 651 is displayed. When receiving a second voice input, the electronic device 20 may recognize negative words “no” and “not” and a keyword ‘grandfather’ based on the second voice input 620, and may determine that the second voice input 620 is another voice input for correcting the meaning of the keyword ‘grandfather’.

On screen 660, the electronic device 20 may correct the displayed keyword ‘grandfather’ to ‘father’ in association with the image 651 based on another voice input and may display an image 661 corresponding to ‘father’. Furthermore, when identifying another voice input, the electronic device 20 may determine a command according to a user's intent based on words recognized based on the second voice input, excluding words recognized in the first voice input 610 from a command determination target. For example, the electronic device 20 may determine the command according to the user's intent based on a sentence “No, not grandfather, please check when father is coming” according to a voice input, excluding a sentence “when will grandfather come today” including a keyword ‘grandfather’.

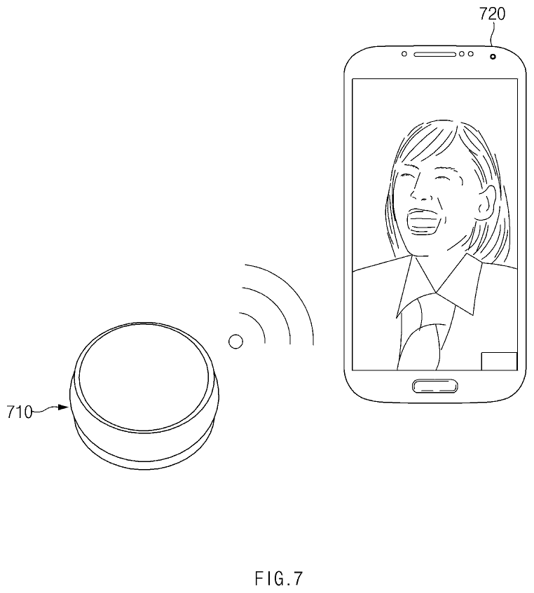

FIG. 7 is an exemplary diagram of an electronic device, which does not include a display or to which another display is set as a display, according to an embodiment.

Referring to FIG. 7, an electronic device 710 may be a device including the microphone 210, the communication circuit 230, the memory 250, and the processor 260, and may be, for example, an AI speaker. In the case where the electronic device 710 does not include a display or the main display of the electronic device 710 is set to a display of an external display device 720, when an image corresponding to a keyword is determined, the processor 260 may transmit an image corresponding to a keyword to the external electronic device 720 (e.g., a smartphone) such that the external electronic device 720 displays the image corresponding to the keyword.

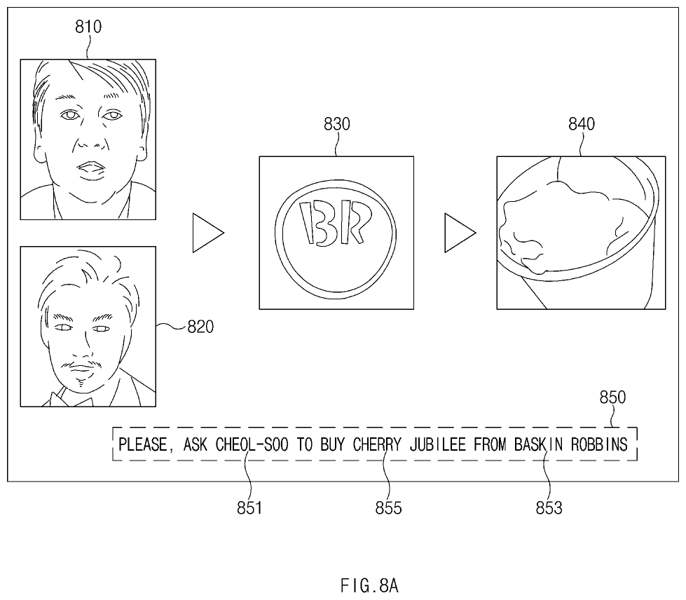

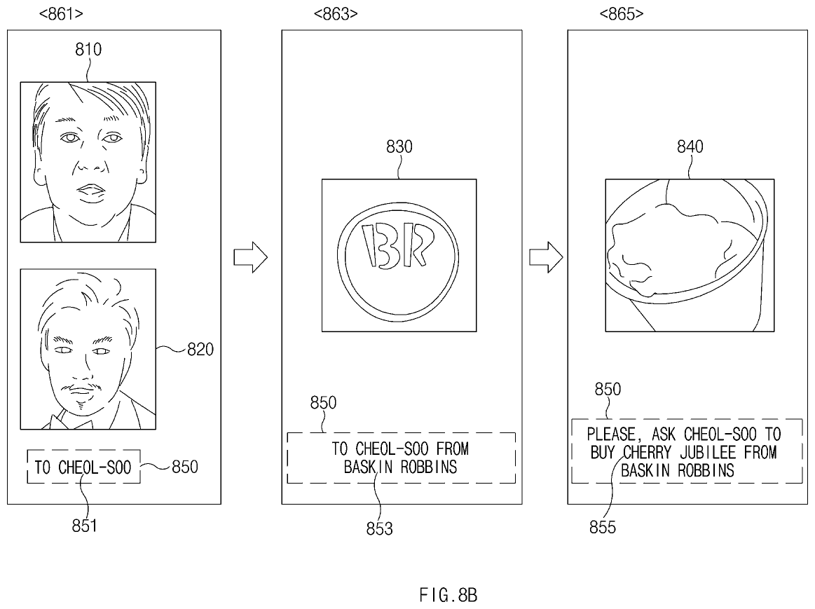

FIGS. 8A and 8B illustrate examples of displaying a plurality of images corresponding to a plurality of keywords according to an embodiment.

Referring to FIG. 8A, the electronic device 20 (e.g., the electronic device 20 of FIG. 2) may detect a plurality of keywords 851, 853, and 855 among one or more words recognized based on a voice input received through a microphone (e.g., the microphone 210 of FIG. 2). In this case, after reception of the voice input is completed, the electronic device 20 may sequentially arrange a plurality of images 810, 820, 830, and 840 corresponding to the plurality of keywords 851, 853, and 855 and then may display the plurality of images 810, 820, 830, and 840 on one screen. In this regard, when a voice input is not received during another specified time, the electronic device 20 may determine that the reception of the voice input is completed. The electronic device 20 may display a sentence 850 composed of one or more words recognized based on a voice input at a lower portion of the plurality of images 810, 820, 830, and 840. As the electronic device 20 arranges the plurality of images 810, 820, 830, and 840 in order in which keywords are detected, and displays the keywords 851, 853, and 855 in the sentences 850 composed of recognized words are displayed in a bold type, the electronic device 20 may display the plurality of images 810, 820, 830, and 840 in association with the keywords 851, 853, and 855.

The electronic device 20 may display the plurality of images 810 and 820 with respect to the keyword “Cheol-soo 851” having a plurality of meanings. In this case, the electronic device 20 may identify an input (e.g., a touch input) to select one of the plurality of images 810 and 820, and then may determine the meaning of the keyword Cheol-soo 851 among a plurality of meanings based on the identified input. The electronic device 20 may execute a command to send a text saying that “please buy cherry jubilee from Baskin Robbins” to Cheol-soo according to contact information 1, based on the determined meaning (e.g., contact information 1 corresponding to image 810).

Referring to FIG. 8B, when detecting the plurality of keywords 851, 853, and 855 among one or more words recognized based on the received voice input, the electronic device 20 may sequentially display the plurality of images 810, 820, 830, and 840 corresponding to the detected plurality of keywords 851, 853, and 855 on a plurality of screens 861, 863, and 865. For example, the electronic device 20 may display the first keyword 851 Cheol-soo', which is detected first, and the images 810 and 820 corresponding to the first keyword 851 Cheol-soo' on the first screen 861. The electronic device 20 may display the second keyword 853 ‘Beskin Robbins’, which is detected second, and the images 830 corresponding to the second keyword 853 ‘Beskin Robbins’ on the second screen 863. The electronic device 20 may display the third keyword 855 “CHERRIES JUBILEE”, which is detected third, and the images 840 corresponding to third keyword 855 “CHERRIES JUBILEE” on the third screen 865.

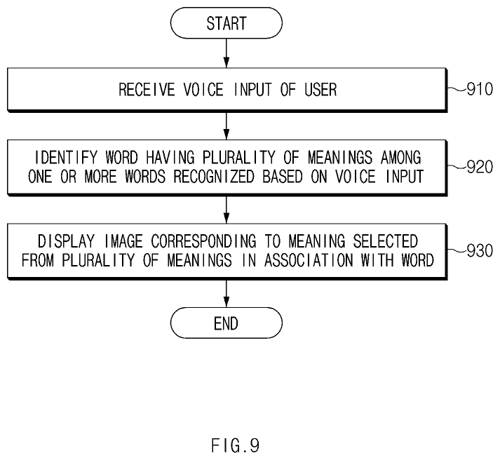

FIG. 9 is a flowchart illustrating a method for displaying an image based on voice recognition according to an embodiment.

Referring to FIG. 9, in operation 910, the electronic device 20 (e.g., the electronic device 20 of FIG. 2) may receive a user's voice input through the microphone 210.

In operation 920, the electronic device 20 may identify a word (keyword) having a plurality of meanings among one or more words recognized based on the received voice input. For example, the electronic device 20 may convert the received voice input into a text, and may identify the word having a plurality of meanings among one or more words based on the converted text. In this process, the electronic device 20 may identify the word having a plurality of meanings among one or more words in cooperation with the intelligence server 10.

In operation 930, the electronic device 20 may display an image corresponding to a meaning selected from a plurality of meanings in association with the word. For example, the electronic device 20 may respectively calculate probabilities of a meaning of the word with respect to a plurality of meanings, based on information about a history, in which the plurality of meanings are used, or information about the user's propensity and may select the meaning with the highest probability among the calculated probabilities as the meaning of the word. The electronic device 20 may obtain an image corresponding to the selected meaning from the memory 250 or an external electronic device (e.g., the intelligence server 10, a portal server, or the like), and may display the obtained image in association with the word.

In the above-described embodiment, before a screen associated with a command determined depending on a user's intent is displayed based on a voice input, the electronic device 20 may display an image corresponding to the selected meaning in association with the word.

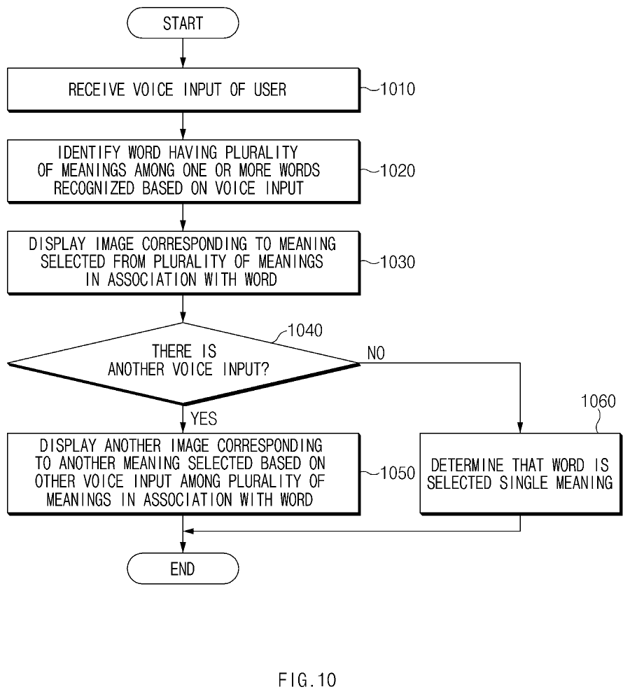

FIG. 10 is a flowchart illustrating an image-based voice recognition error verifying method according to an embodiment.

Referring to FIG. 10, in operation 1010, the electronic device 20 (e.g., the electronic device 20 of FIG. 2) may receive a user's voice input through the microphone 210 (e.g., the microphone 210 of FIG. 2).

In operation 1020, the electronic device 20 may identify a word (hereinafter, referred to as a “keyword”) having a plurality of meanings among one or more words recognized based on the received voice input. For example, the electronic device 20 may convert the received voice input into a text, and may identify the word having a plurality of meanings among one or more words based on the converted text. In this process, the electronic device 20 may identify a word having a plurality of meanings among one or more words in cooperation with the intelligence server 10.

In operation 1030, the electronic device 20 may display an image corresponding to a meaning selected from a plurality of meanings in association with a keyword. For example, the electronic device 20 may respectively calculate probabilities of a meaning of the keyword with respect to a plurality of meanings, based on information about a history, in which the plurality of meanings are used, or information about the user's propensity and may select the meaning with the highest probability among the calculated probabilities as the meaning of the keyword. The electronic device 20 may obtain an image corresponding to the selected single meaning from the memory 250 or an external electronic device (e.g., the intelligence server 10, a portal server, or the like), and may display the obtained image in association with the word.

In operation 1040, the electronic device 20 may determine whether there is another voice input to the displayed image in association with the keyword. For example, when recognizing a keyword and a word associated with another meaning of a plurality of meanings based on a voice input received within a specified time after the image is displayed, the electronic device 20 may identify that there is another voice input.

When there is another voice input, in operation 1050, the electronic device 20 may display another image corresponding to another meaning, which is selected based on the other voice input, from among the plurality of meanings, which a keyword has, in association with the keyword. For example, the electronic device 20 may obtain another image corresponding to another meaning from the memory 250 or an external electronic device (e.g., the intelligence server 10) and may display another image in association with the keyword.

According to the above-described embodiment, because the electronic device 20 may display an image associated with a keyword in a voice recognition process, thereby supporting a user to intuitively identify and correct an error in the voice recognition process.

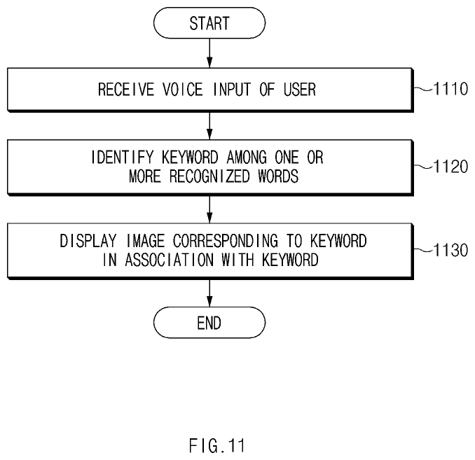

FIG. 11 illustrates another example of an image-based voice recognition error verifying method according to an embodiment.

Referring to FIG. 11, in operation 1110, the electronic device 20 (e.g., the electronic device 20 of FIG. 2) may receive a user's voice input through the microphone 210 (e.g., the microphone 210 of FIG. 2). For example, the electronic device 20 may convert the received voice input into a text, and may identify the word having a plurality of meanings among one or more words based on the converted text. In this process, the electronic device 20 may identify a word having a plurality of meanings among one or more words in cooperation with the intelligence server 10.

In operation 1120, the electronic device 20 may detect a keyword among one or more words recognized based on the received voice input. For example, the electronic device 20 may detect a word having a plurality of meanings, a word associated with a name, or a word associated with an action among the one or more recognized words as the keyword.

In operation 1130, the electronic device 20 may display an image corresponding to the keyword through the display 240 in association with the keyword. For example, the electronic device 20 may obtain another image corresponding to another meaning from the memory 250 or an external electronic device (e.g., the intelligence server 10) and may display another image in association with the keyword.

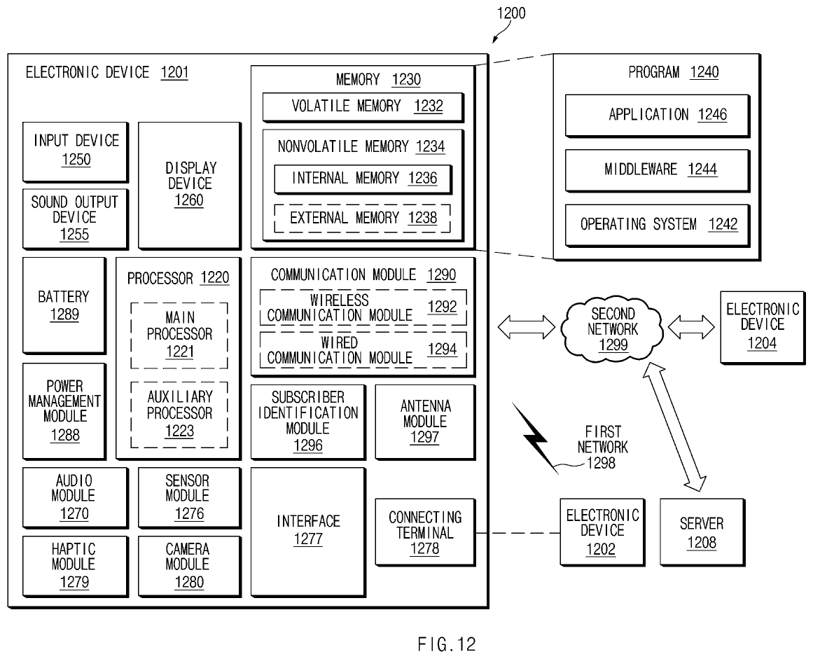

FIG. 12 is a block diagram illustrating an electronic device 1201 in a network environment 1200 according to various embodiments. Referring to FIG. 12, the electronic device 1201 (e.g., the electronic device 20 of FIG. 2) in the network environment 1200 may communicate with an electronic device 1202 via a first network 1298 (e.g., a short-range wireless communication network), or an electronic device 1204 or a server 1208 (e.g., the intelligence server 10 of FIG. 1) via a second network 1299 (e.g., a long-range wireless communication network). According to an embodiment, the electronic device 1201 may communicate with the electronic device 1204 via the server 1208. According to an embodiment, the electronic device 1201 may include a processor 1220 (e.g., the processor 260 of FIG. 2), memory 1230 (e.g., the memory 250 of FIG. 2), an input device 1250 (e.g., the microphone 210 and the input circuit 220 of FIG. 2), a sound output device 1255, a display device 1260 (e.g., the display 240 of FIG. 2), an audio module 1270, a sensor module 1276, an interface 1277, a haptic module 1279, a camera module 1280, a power management module 1288, a battery 1289, a communication module 1290, a subscriber identification module(SIM) 1296, or an antenna module 1297. In some embodiments, at least one (e.g., the display device 1260 or the camera module 1280) of the components may be omitted from the electronic device 1201, or one or more other components may be added in the electronic device 1201. In some embodiments, some of the components may be implemented as single integrated circuitry. For example, the sensor module 1276 (e.g., a fingerprint sensor, an iris sensor, or an illuminance sensor) may be implemented as embedded in the display device 1260 (e.g., a display).

The processor 1220 may execute, for example, software (e.g., a program 1240) to control at least one other component (e.g., a hardware or software component) of the electronic device 1201 coupled with the processor 1220, and may perform various data processing or computation. According to one embodiment, as at least part of the data processing or computation, the processor 1220 may load a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), and an auxiliary processor 1223 (e.g., a graphics processing unit (GPU), an image signal processor (ISP), a sensor hub processor, or a communication processor (CP)) that is operable independently from, or in conjunction with, the main processor 1221. Additionally or alternatively, the auxiliary processor 1223 may be adapted to consume less power than the main processor 1221, or to be specific to a specified function. The auxiliary processor 1223 may be implemented as separate from, or as part of the main processor 1221.

The auxiliary processor 1223 may control at least some of functions or states related to at least one component (e.g., the display device 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input device 1250 may receive a command or data to be used by other component (e.g., the processor 1220) of the electronic device 1201, from the outside (e.g., a user) of the electronic device 1201. The input device 1250 may include, for example, a microphone, a mouse, a keyboard, or a digital pen (e.g., a stylus pen).

The sound output device 1255 may output sound signals to the outside of the electronic device 1201. The sound output device 1255 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 1260 may visually provide information to the outside (e.g., a user) of the electronic device 1201. The display device 1260 may include, for example, a display, a hologram device, or a projector and control circuitry to control a corresponding one of the display, hologram device, and projector. According to an embodiment, the display device 1260 may include touch circuitry adapted to detect a touch, or sensor circuitry (e.g., a pressure sensor) adapted to measure the intensity of force incurred by the touch.

The audio module 1270 may convert a sound into an electrical signal and vice versa. According to an embodiment, the audio module 1270 may obtain the sound via the input device 1250, or output the sound via the sound output device 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, a HDMI connector, a USB connector, a SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to one embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The antenna module 1297 may transmit or receive a signal or power to or from the outside (e.g., the external electronic device) of the electronic device 1201. According to an embodiment, the antenna module 1297 may include an antenna including a radiating element composed of a conductive material or a conductive pattern formed in or on a substrate (e.g., PCB). According to an embodiment, the antenna module 1297 may include a plurality of antennas. In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 and 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, or client-server computing technology may be used, for example.

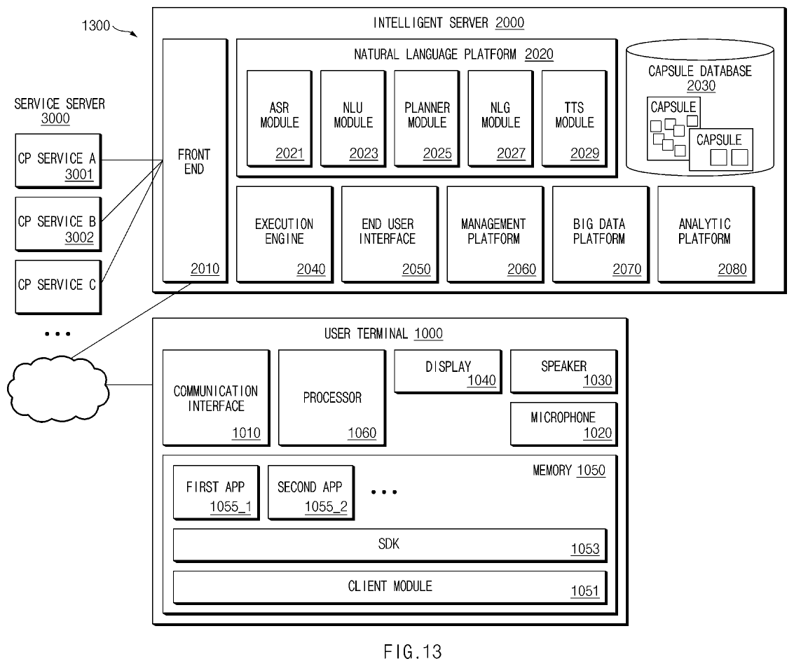

FIG. 13 is a block diagram illustrating an integrated intelligence system, according to an embodiment.

Referring to FIG. 13, according to an embodiment, an integrated intelligence system 3000 may include a user terminal 1000 (e.g., the electronic device 20 of FIG. 1), an intelligence server 2000 (e.g., the intelligence server 10 of FIG. 1), and a service server 3000.

The user terminal 1000 according to an embodiment may be a terminal device (or an electronic device) capable of connecting to Internet, and may be, for example, a mobile phone, a smartphone, a personal digital assistant (PDA), a notebook computer, TV, a white household appliance, a wearable device, a HMD, or a smart speaker.

According to the illustrated embodiment, the user terminal 1000 may include a communication interface 1010 (e.g., the communication circuit 230 of FIG. 2), a microphone 1020 (e.g., the microphone 210 of FIG. 2), a speaker 1030, a display 1040 (e.g., the display 240 of FIG. 2), a memory 1050 (e.g., the memory 250 of FIG. 2), or a processor 1060 (e.g., the processor 260 of FIG. 2). The listed components may be operatively or electrically connected to one another.

The communication interface 1010 according to an embodiment may be connected to an external device and may be configured to transmit or receive data to or from the external device. The microphone 1020 according to an embodiment may receive a sound (e.g., a user utterance) to convert the sound into an electrical signal. The speaker 1030 according to an embodiment may output the electrical signal as a sound (e.g., voice). The display 1040 according to an embodiment may be configured to display an image or a video. The display 1040 according to an embodiment may display the graphic user interface (GUI) of the running app (or an application program).

The memory 1050 according to an embodiment may store a client module 1051, a software development kit (SDK) 1053, and a plurality of apps 1055. The client module 1051 and the SDK 1053 may constitute a framework (or a solution program) for performing general-purposed functions. Furthermore, the client module 1051 or the SDK 1053 may constitute the framework for processing a voice input.

In the memory 1050 according to an embodiment, the plurality of apps 1055 may be programs for performing the specified function. According to an embodiment, the plurality of apps 1055 may include a first app 1055_1 and a second app 1055_2. According to an embodiment, each of the plurality of apps 1055 may include a plurality of actions for performing a specified function. For example, the apps may include an alarm app, a message app, and/or a schedule app. According to an embodiment, the plurality of apps 1055 may be executed by the processor 1060 to sequentially execute at least part of the plurality of actions.

According to an embodiment, the processor 1060 may control overall operations of the user terminal 1000. For example, the processor 1060 may be electrically connected to the communication interface 1010, the microphone 1020, the speaker 1030, and the display 1040 to perform a specified operation.

Moreover, the processor 1060 according to an embodiment may execute the program stored in the memory 1050 to perform a specified function. For example, according to an embodiment, the processor 1060 may execute at least one of the client module 1051 or the SDK 1053 to perform a following operation for processing a voice input. The processor 1060 may control operations of the plurality of apps 1055 via the SDK 1053. The following operation described as an operation of the client module 1051 or the SDK 1053 may be executed by the processor 1060.

According to an embodiment, the client module 1051 may receive a voice input. For example, the client module 1051 may receive a voice signal corresponding to a user utterance detected through the microphone 1020. The client module 1051 may transmit the received voice input to the intelligence server 2000. The client module 1051 may transmit state information of the user terminal 1000 to the intelligence server 2000 together with the received voice input. For example, the state information may be execution state information of an app.

According to an embodiment, the client module 1051 may receive a result corresponding to the received voice input. For example, when the intelligence server 2000 is capable of calculating the result corresponding to the received voice input, the client module 1051 may receive the result corresponding to the received voice input. The client module 1051 may display the received result on the display 1040.

According to an embodiment, the client module 1051 may receive a plan corresponding to the received voice input. The client module 1051 may display, on the display 1040, a result of executing a plurality of actions of an app depending on the plan. For example, the client module 1051 may sequentially display the result of executing the plurality of actions on a display. For another example, the user terminal 1000 may display only a part of results (e.g., a result of the last action) of executing the plurality of actions, on the display.

According to an embodiment, the client module 1051 may receive a request for obtaining information necessary to calculate the result corresponding to a voice input, from the intelligence server 2000. According to an embodiment, the client module 1051 may transmit the necessary information to the intelligence server 2000 in response to the request.

According to an embodiment, the client module 1051 may transmit, to the intelligence server 2000, information about the result of executing a plurality of actions depending on the plan. The intelligence server 2000 may identify that the received voice input is correctly processed, using the result information.

According to an embodiment, the client module 1051 may include a speech recognition module. According to an embodiment, the client module 1051 may recognize a voice input for performing a limited function, via the speech recognition module. For example, the client module 1051 may launch an intelligence app that processes a voice input for performing an organic action, via a specified input (e.g., wake up!).

According to an embodiment, the intelligence server 2000 may receive information associated with a user's voice input from the user terminal 1000 over a communication network. According to an embodiment, the intelligence server 2000 may convert data associated with the received voice input to text data. According to an embodiment, the intelligence server 2000 may generate a plan for performing a task corresponding to the user's voice input, based on the text data.

According to an embodiment, the plan may be generated by an artificial intelligent (AI) system. The AI system may be a rule-based system, or may be a neural network-based system (e.g., a feedforward neural network (FNN) or a recurrent neural network (RNN)). Alternatively, the AI system may be a combination of the above-described systems or an AI system different from the above-described system. According to an embodiment, the plan may be selected from a set of predefined plans or may be generated in real time in response to a user request. For example, the AI system may select at least one plan of the plurality of predefined plans.

According to an embodiment, the intelligence server 2000 may transmit a result according to the generated plan to the user terminal 1000 or may transmit the generated plan to the user terminal 1000. According to an embodiment, the user terminal 1000 may display the result according to the plan, on a display. According to an embodiment, the user terminal 1000 may display a result of executing the action according to the plan, on the display.

The intelligence server 2000 according to an embodiment may include a front end 2010, a natural language platform 2020, a capsule database (DB) 2030, an execution engine 2040, an end user interface 2050, a management platform 2060, a big data platform 2070, or an analytic platform 2080.

According to an embodiment, the front end 2010 may receive a voice input from the user terminal 1000. The front end 2010 may transmit a response corresponding to the voice input.

According to an embodiment, the natural language platform 2020 may include an automatic speech recognition (ASR) module 2021, a natural language understanding (NLU) module 2023, a planner module 2025, a natural language generator (NLG) module 2027, or a text to speech module (TTS) module 2029.

According to an embodiment, the ASR module 2021 may convert the voice input received from the user terminal 1000 into text data. According to an embodiment, the NLU module 2023 may grasp the intent of the user, using the text data of the voice input. For example, the NLU module 2023 may grasp the intent of the user by performing syntactic analysis or semantic analysis. According to an embodiment, the NLU module 2023 may grasp the meaning of words extracted from the voice input by using linguistic features (e.g., syntactic elements) such as morphemes or phrases and may determine the intent of the user by matching the grasped meaning of the words to the intent.

According to an embodiment, the planner module 2025 may generate the plan by using the intent and a parameter, which are determined by the NLU module 2023. According to an embodiment, the planner module 2025 may determine a plurality of domains necessary to perform a task, based on the determined intent. The planner module 2025 may determine a plurality of actions included in each of the plurality of domains determined based on the intent. According to an embodiment, the planner module 2025 may determine the parameter necessary to perform the determined plurality of actions or a result value output by the execution of the plurality of actions. The parameter and the result value may be defined as a concept of a specified form (or class). As such, the plan may include the plurality of actions and a plurality of concepts, which are determined by the intent of the user. The planner module 2025 may determine the relationship between the plurality of actions and the plurality of concepts stepwise (or hierarchically). For example, the planner module 2025 may determine the execution sequence of the plurality of actions, which are determined based on the user's intent, based on the plurality of concepts. In other words, the planner module 2025 may determine an execution sequence of the plurality of actions, based on the parameters necessary to perform the plurality of actions and the result output by the execution of the plurality of actions. Accordingly, the planner module 2025 may generate a plan including information (e.g., ontology) about the relationship between the plurality of actions and the plurality of concepts. The planner module 2025 may generate the plan, using information stored in the capsule DB 2030 storing a set of relationships between concepts and actions.

According to an embodiment, the NLG module 2027 may change specified information into information in a text form. The information changed to the text form may be in the form of a natural language speech. The TTS module 2029 according to an embodiment may change information in the text form to information in a voice form.

According to an embodiment, all or part of the functions of the natural language platform 2020 may be also implemented in the user terminal 1000.

The capsule DB 2030 may store information about the relationship between the actions and the plurality of concepts corresponding to a plurality of domains. According to an embodiment, the capsule may include a plurality of action objects (or action information) and concept objects (or concept information) included in the plan. According to an embodiment, the capsule DB 2030 may store the plurality of capsules in a form of a concept action network (CAN). According to an embodiment, the plurality of capsules may be stored in the function registry included in the capsule DB 2030.

The capsule DB 2030 may include a strategy registry that stores strategy information necessary to determine a plan corresponding to a voice input. When there are a plurality of plans corresponding to the voice input, the strategy information may include reference information for determining one plan. According to an embodiment, the capsule DB 2030 may include a follow-up registry that stores information of the follow-up action for suggesting a follow-up action to the user in a specified context. For example, the follow-up action may include a follow-up utterance. According to an embodiment, the capsule DB 2030 may include a layout registry storing layout information of information output via the user terminal 1000. According to an embodiment, the capsule DB 2030 may include a vocabulary registry storing vocabulary information included in capsule information. According to an embodiment, the capsule DB 2030 may include a dialog registry storing information about dialog (or interaction) with the user. The capsule DB 2030 may update an object stored via a developer tool. For example, the developer tool may include a function editor for updating an action object or a concept object. The developer tool may include a vocabulary editor for updating a vocabulary. The developer tool may include a strategy editor that generates and registers a strategy for determining the plan. The developer tool may include a dialog editor that creates a dialog with the user. The developer tool may include a follow-up editor capable of activating a follow-up target and editing the follow-up utterance for providing a hint. The follow-up target may be determined based on a target, the user's preference, or an environment condition, which is currently set. The capsule DB 2030 according to an embodiment may be also implemented in the user terminal 1000.

According to an embodiment, the execution engine 2040 may calculate a result by using the generated plan. The end user interface 2050 may transmit the calculated result to the user terminal 1000. Accordingly, the user terminal 1000 may receive the result and may provide the user with the received result. According to an embodiment, the management platform 2060 may manage information used by the intelligence server 2000. According to an embodiment, the big data platform 2070 may collect data of the user. According to an embodiment, the analytic platform 2080 may manage quality of service (QoS) of the intelligence server 2000. For example, the analytic platform 2080 may manage the component and processing speed (or efficiency) of the intelligence server 2000.

According to an embodiment, the service server 3000 may provide the user terminal 1000 with a specified service (e.g., food order or hotel reservation). According to an embodiment, the service server 3000 may be a server operated by the third party. According to an embodiment, the service server 3000 may provide the intelligence server 2000 with information for generating a plan corresponding to the received voice input. The provided information may be stored in the capsule DB 2030. Furthermore, the service server 3000 may provide the intelligence server 2000 with result information according to the plan.

In the above-described integrated intelligence system 3000, the user terminal 1000 may provide the user with various intelligent services in response to a user input. The user input may include, for example, an input through a physical button, a touch input, or a voice input.

According to an embodiment, the user terminal 1000 may provide a speech recognition service via an intelligence app (or a speech recognition app) stored therein. In this case, for example, the user terminal 1000 may recognize a user utterance or a voice input, which is received via the microphone, and may provide the user with a service corresponding to the recognized voice input.

According to an embodiment, the user terminal 1000 may perform a specified action, based on the received voice input, independently, or together with the intelligence server and/or the service server. For example, the user terminal 1000 may launch an app corresponding to the received voice input and may perform the specified action via the executed app.

According to an embodiment, when providing a service together with the intelligence server 2000 and/or the service server, the user terminal 1000 may detect a user utterance by using the microphone 1020 and may generate a signal (or voice data) corresponding to the detected user utterance. The user terminal may transmit the voice data to the intelligence server 2000, using the communication interface 1010.

According to an embodiment, the intelligence server 2000 may generate a plan for performing a task corresponding to the voice input or the result of performing an action depending on the plan, as a response to the voice input received from the user terminal 1000. For example, the plan may include a plurality of actions for performing a task corresponding to the voice input of the user and a plurality of concepts associated with the plurality of actions. The concept may define a parameter to be input upon executing the plurality of actions or a result value output by the execution of the plurality of actions. The plan may include relationship information between the plurality of actions and the plurality of concepts.

According to an embodiment, the user terminal 1000 may receive the response, using the communication interface 1010. The user terminal 1000 may output the voice signal generated in the user terminal 1000 to the outside by using the speaker 1030 or may output an image generated in the user terminal 1000 to the outside by using the display 1040.

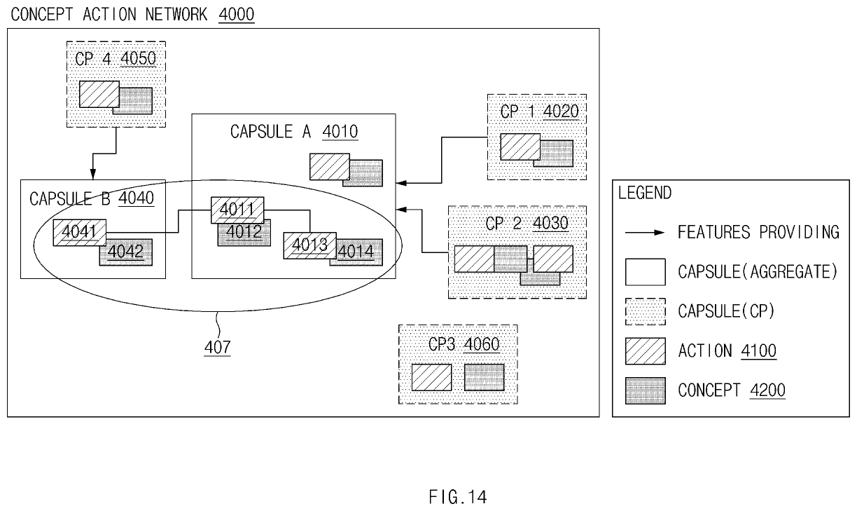

FIG. 14 is a diagram illustrating a form in which relationship information between a concept and an action is stored in a database, according to various embodiments.

A capsule database (e.g., the capsule DB 2030) of the intelligence server 2000 may store a capsule in the form of a concept action network (CAN). The capsule DB may store an action for processing a task corresponding to a user's voice input and a parameter necessary for the action, in the CAN form.

The capsule DB may store a plurality capsules capsule A 4010 and capsule B 4040 respectively corresponding to a plurality of domains (e.g., applications). According to an embodiment, a single capsule (e.g., the capsule A 4010) may correspond to a single domain (e.g., a location (geo) or an application). Furthermore, at least one service provider (e.g., CP 1 4020 or CP 2 4030) for performing a function for a domain associated with the capsule may correspond to one capsule. According to an embodiment, the single capsule may include at least one or more actions 4100 and at least one or more concepts 4200 for performing a specified function.

The natural language platform 2020 may generate a plan for performing a task corresponding to the received voice input, using the capsule stored in a capsule database. For example, the planner module 2025 of the natural language platform may generate the plan by using the capsule stored in the capsule database. For example, a plan 4070 may be generated by using actions 4011 and 4013 and concepts 4012 and 4014 of the capsule A 4010 and an action 4041 and a concept 4042 of the capsule B 4040.

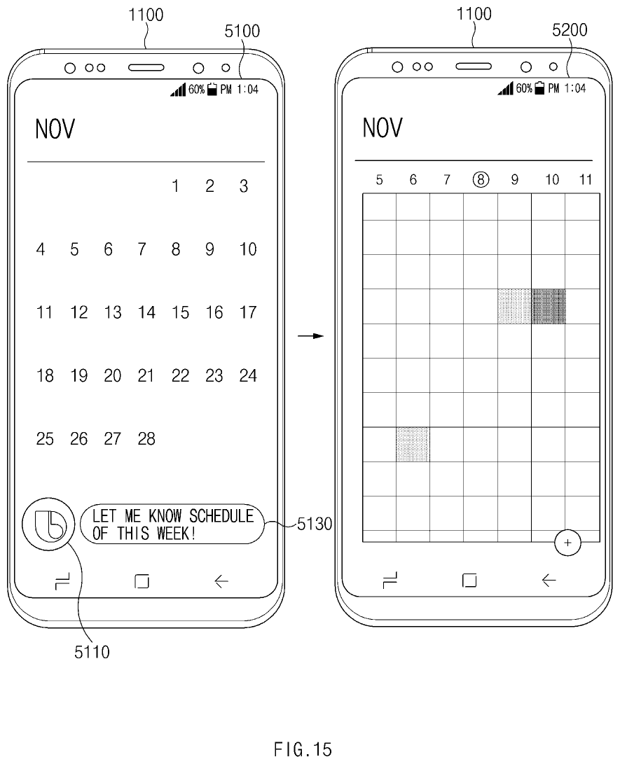

FIG. 15 is a view illustrating a screen in which a user terminal processes a voice input received through an intelligence app, according to various embodiments.

The user terminal 1000 may execute an intelligence app to process a user input through the intelligence server 2000.

According to an embodiment, on screen 5100, when recognizing a specified voice input (e.g., wake up!) or receiving an input via a hardware key (e.g., a dedicated hardware key), the user terminal 1000 may launch an intelligence app for processing a voice input. For example, the user terminal 1000 may launch the intelligence app in a state where a schedule app is executed. According to an embodiment, the user terminal 1000 may display an object (e.g., an icon) 5110 corresponding to the intelligence app, on the display 1040. According to an embodiment, the user terminal 1000 may receive a voice input by a user utterance. For example, the user terminal 1000 may receive a voice input saying that “Let me know the schedule of this week!”. According to an embodiment, the user terminal 1000 may display a user interface (UI) 5130 (e.g., an input window) of an intelligence app, in which text data of the received voice input is displayed, on a display

According to an embodiment, on screen 5200, the user terminal 1000 may display a result corresponding to the received voice input, on the display. For example, the user terminal 1000 may receive the plan corresponding to the received user input and may display ‘the schedule of this week’ on the display depending on the plan.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1240) including one or more instructions that are stored in a storage medium (e.g., internal memory 1236 or external memory 1238) that is readable by a machine (e.g., the electronic device 1201). For example, a processor (e.g., the processor 1220) of the machine (e.g., the electronic device 1201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a microphone;
a display; and
a processor, wherein the processor is configured to:
receive a voice input of a user through the microphone;
identify a word having a plurality of meanings among one or more words recognized based on the voice input, in response to the voice input; and
display an image corresponding to one meaning selected from the plurality of meanings through the display in association with the word.

2. The electronic device of claim 1, wherein the processor is configured to:
when there is another voice input to the image displayed in association with the word, display another image corresponding to another meaning selected based on the another voice input among the plurality of meanings in response to the another voice input through the display in association with the word.

3. The electronic device of claim 2, wherein the processor is configured to:
calculate probabilities of a meaning according to the voice input with respect to the plurality of meanings, respectively; and
select the one meaning corresponding to the highest probability among the calculated probabilities.

4. The electronic device of claim 3, wherein the processor is further configured to:
calculate the probabilities respectively associated with the plurality of meanings based on a history in which the word is used by the electronic device or an external electronic device.

5. The electronic device of claim 2, wherein the processor is configured to:
when recognizing a word associated with another meaning that is not selected from the plurality of meanings based on the voice input within a specified time, determine that the another voice input is present.

6. The electronic device of claim 5, wherein the processor is configured to:
when recognizing at least one word of a negative word or a pronoun as well as the word associated with the another meaning within the specified time based on the voice input, determine that the another voice input is present.

7. The electronic device of claim 1, further comprising:
an input circuit,
wherein the processor is configured to:
when identifying the word having the plurality of meanings, display a plurality of images respectively corresponding to the plurality of meanings through the display in association with the word; and
display the image corresponding to the one meaning corresponding to one image selected through the input circuit among the plurality of images through the display.

8. The electronic device of claim 2, wherein the processor is configured to:
when the another voice input to the image displayed in association with the word is not present, determine the word as the selected one meaning.

9. The electronic device of claim 8, further comprising:
a communication circuit configured to communicate with an external electronic device,
wherein the processor is configured to:
transmit the voice input and the another voice input to the external electronic device such that the external electronic device determines whether the another voice input to the image displayed in association with the word is present, and determines the one meaning among the plurality of meanings based on the another voice input.

10. An electronic device comprising:
a microphone;
a display;
a processor operatively connected to the microphone and the display; and
a memory operatively connected to the processor,
wherein the memory stores instructions that, when executed, cause the processor to:
receive a voice input of a user through the microphone;
detect a keyword among one or more words recognized based on the received voice input; and
display an image corresponding to the keyword through the display in association with the keyword.

11. The electronic device of claim 10, wherein the instructions further cause the processor to:
when the keyword is a word having a plurality of meanings, display a plurality of images corresponding to the plurality of meanings;
calculate probabilities of a meaning of the keyword with respect to the plurality of meanings, respectively; and
display an image among plurality of images corresponding to the one meaning having the highest probability among the calculated probabilities at the largest size; and
display an image corresponding to one meaning selected from the plurality of meanings through the display based on an user input for selecting one image among the plurality of images.

12. The electronic device of claim 10, wherein the instructions further cause the processor to:
when there is another voice input to the image displayed in association with the keyword, correct the keyword based on the another voice input.

13. The electronic device of claim 10, wherein the instructions further cause the processor to:
when there is another voice input to the image displayed in association with the keyword, exclude a sentence including the keyword; and
determine a command based on a voice input excluding the sentence.

14. The electronic device of claim 12, wherein the instructions cause the processor to:
when a voice input including at least one of the keyword, a negative word, or a pronoun is received within a specified time, determine that the another voice input is present.

15. The electronic device of claim 10, wherein the instructions further cause the processor to:
when the reception of the voice input is terminated, determine a command according to intent of the user based on the voice input;
display a screen associated with the command through the display, in an execution process or an execution termination of the command; and
display the image until the screen associated with the command is displayed.

16. The electronic device of claim 13, wherein the instructions cause the processor to:
when a voice input including at least one of the keyword, a negative word, or a pronoun is received within a specified time, determine that the another voice input is present.
